(19) United States
(12) Patent Application Publication
(10) Pub. No.: US 2012/0171957 A1
(43) Pub. Date: Jul. 5, 2012

(54) UNIVERSAL SERIAL BUS MOUSE

(75) Inventors: CHIEN-HUNG LO, Tu-Cheng (TW); HAI-LI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/985,359

(22) Filed: Jan. 6, 2011

(30) Foreign Application Priority Data
Dec. 29, 2010 (CN) 201010612759.7

(51) Int. Cl. H04B 7/00

(52) U.S. Cl. 455/41.2

(57) ABSTRACT

A universal serial bus (USB) mouse includes a USB plug, a USB hub circuit, a mouse control circuit, a BLUETOOTH module, a network adapter, and an antenna. The USB hub circuit is connected to the USB plug. The mouse control circuit is connected to the USB hub circuit. The BLUETOOTH module is connected to the USB hub circuit. The network adapter is connected to the USB hub circuit and the BLUETOOTH module. The antenna is connected to the BLUETOOTH module. The BLUETOOTH module together with the antenna functions as a BLUETOOTH receiver. The network adapter transmits network data through the BLUETOOTH module and with the antenna.

### BACKGROUND

1. Technical Field

The present disclosure relates to a universal serial bus (USB) mouse.

2. Description of Related Art

Nowadays, computers are widely used in our life. A computer mouse is one of the most important peripheral devices of a computer. Although a computer mouse can be connected to a computer through a variety of interfaces, nowadays, the USB interface is the most ubiquitous. However, the USB mouse only functions as an input device, therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of a universal serial bus (USB) mouse.

FIG. 2 is an isometric, schematic view of the USB mouse of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

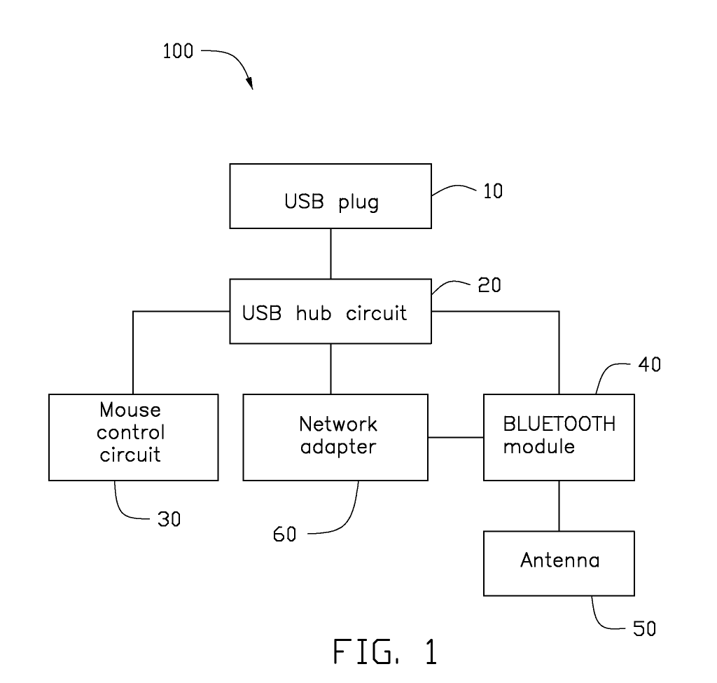

Referring to FIG. 1, an embodiment of a universal serial bus (USB) mouse 100 includes a USB plug 10, a USB hub circuit 20, a mouse control circuit 30, a BLUETOOTH module 40, an antenna 50, and a network adapter 60.

The USB plug 10 is used to be connected to a USB interface of a computer (not shown). The USB plug 10 is connected to the mouse control circuit 30, the BLUETOOTH module 40, and the network adapter 60, through the USB hub circuit 20. The BLUETOOTH module 40 is connected to the antenna 50 and the network adapter 60. The USB hub circuit 20 functions as a USB hub to allow the USB plug 10 to synchronously communicate with the mouse control circuit 30, the BLUETOOTH module 40, and the network adapter 60. The mouse control circuit 30 is used to control the mouse 100 to function as an input device to control the computer. The BLUETOOTH module 40 together with the antenna 50 functions as a BLUETOOTH receiver. The network adapter 60 is used to communicate with an external BLUETOOTH device, such as a cell phone. The USB hub circuit 20, the mouse control circuit 30, the BLUETOOTH module 40, and the network adapter 60 all fall within well-known technologies, and are therefore not further described here.

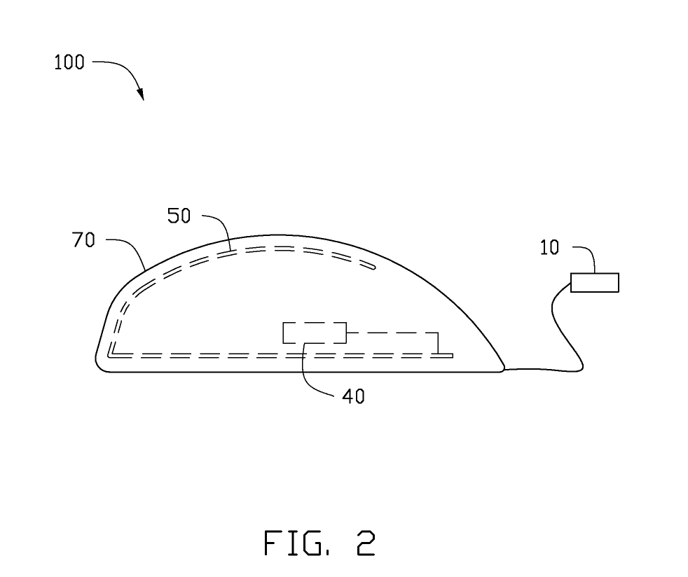

Referring to FIG. 2, the antenna 50 is housed in a case 70 of the mouse 100. In one embodiment, the antenna 50 is designed to substantially surround an inside wall of the case 70, therefore increasing the length of the antenna 50, and thus increasing the signal receiving effect. The antenna 50 is used to receive BLUETOOTH signals from external BLUETOOTH devices and transmit the received BLUETOOTH signals to the BLUETOOTH module 40, and used to receive BLUETOOTH signals from the computer through the BLUETOOTH module 40 and then transmit the received BLUETOOTH signals to the external BLUETOOTH devices.

In use, the USB plug 10 is inserted in the USB interface of the computer, at this time, the mouse control circuit 30, the BLUETOOTH module 40, and the network adapter 60 can work synchronously through the USB hub circuit 20. Firstly, the mouse control circuit 30 can make the mouse 100 function as a normal mouse to control the computer. Secondly, the BLUETOOTH module 40 with the antenna 50 can communicate as an external BLUETOOTH device with the computer. Thirdly, the external BLUETOOTH device can access the network data from the computer through the network adapter 60 together with the BLUETOOTH module 40 and the antenna 50, which is very convenient. Furthermore, the computer does not need to have a BLUETOOTH receiver, a network adapter, or an antenna installed, which can increase performance of the computer.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A universal serial bus (USB) mouse comprising:
a USB plug;
a USB hub circuit connected to the USB plug;
a mouse control circuit connected to the USB hub circuit;
a BLUETOOTH module connected to the USB hub circuit;
a network adapter connected to the USB hub circuit and the BLUETOOTH module; and
an antenna connected to the BLUETOOTH module;
wherein the BLUETOOTH module together with the antenna functions as a BLUETOOTH receiver, the network adapter is operable to transmit network data through the BLUETOOTH module and with the antenna.

2. The USB mouse of claim 1, wherein the antenna substantially surrounds an inside wall of a case of the USB mouse.
